(19) United States
(12) Patent Application Publication
(10) Pub. No.: US 2025/0238669 A1
(43) Pub. Date: Jul. 24, 2025

(54) System Behavior Analysis Using Foundation Models

(71) Applicant: International Business Machines Corporation, Armonk, NY (US)

(72) Inventors: Youngja PARK, Princeton, NJ (US); Kevin EYKHOLT, Cambridge, MA (US); Taesung LEE, Ridgefield, CT (US); Ian Michael MOLLOY, Chappaqua, NY (US); Xiaokui SHU, Ossining, NY (US); Jiyong JANG, Chappaqua, NY (US); Axel TANNER, Kilchberg (CH); Mariam HAKOBYAN-SOBIROV, Solothurn (CH); Andreas WESPI, Niederhasli (CH)

(21) Appl. No.: 18/416,683

(22) Filed: Jan. 18, 2024

(51) Int. Cl. G06N 3/08

(52) U.S. Cl. CPC G06N 3/08

(57) ABSTRACT

A computer-implemented method (CIM), according to one approach, includes: aggregating system log information and converting the system log information to sentences. The sentences are used to train a foundation model based on the system log information. Moreover, the foundation model is augmented using Siamese augmentation. The foundation model is also tuned for a downstream application. The downstream application can thereby be implemented using the foundation model.

### BACKGROUND

The present invention relates to machine learning models, and more specifically, this invention relates to developing foundation models that are used as a base for building task specific machine learning models for system behavior analysis.

Data production continues to increase as computing power advances. For instance, the rise of smart enterprise endpoints has led to large amounts of data being generated at remote locations. Data production will only further increase with the growth of 5G networks and an increased number of connected mobile devices. As data production increases, so does the overhead associated with processing the larger amounts of data. Processing overhead is further increased when dealing with unstructured data and as different types of information are involved. For example, video and audio data may be combined in a pool of unstructured data, which results in longer processing times.

Artificial intelligence has been developed in an attempt to combat this rise in processing overhead. For instance, machine learning models may be used to inspect large amounts of data and draw inferences from patterns in the data. While this has reduced the amount of time that is spent analyzing data, advancements in artificial intelligence and sample sizes have also continued to increase, making data processing times and overhead a continued area of focus.

Conventional applications of artificial intelligence involve building rule based systems or machine learning models that are task specific. In other words, models are developed and trained for a specific assignment. For example, a conventional anomaly detection system that applies machine learning is formed by creating training data for the particular problem being faced, and using the training data to teach the system. This is a complex and resource intensive process. Furthermore, as the problem changes over time, new training data needs to be developed and used to modify the abilities of the system.

### SUMMARY

A computer-implemented method (CIM), according to one approach, includes: aggregating system log information and converting the system log information to sentences. The sentences are used to train a foundation model based on the system log information. Moreover, the foundation model is augmented using Siamese augmentation. The foundation model is also tuned for a downstream application. The downstream application can thereby be implemented using the foundation model.

A computer program product (CPP), according to another approach, includes: a set of one or more computer-readable storage media. Moreover, program instructions are collectively stored in the set of one or more storage media. The program instructions are for causing a processor set to perform the foregoing CIM.

A computer system (CS), according to yet another approach, includes: a processor set and a set of one or more computer-readable storage media. The CS also includes program instructions that are collectively stored in the set of one or more storage media. The program instructions are for causing the processor set to perform the foregoing CIM.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3A is a flowchart of a method, in accordance with one approach.

FIG. 3B is a flowchart of a method for training a Siamese model, in accordance with one approach.

FIG. 4 is a flowchart of a method for developing a downstream model using a foundation model and a Siamese model, in accordance with one approach.

FIG. 5A is a table outlining different machine learning models and the experimental accuracy readings they are able to achieve without using the foundation model, in accordance with one approach.

FIG. 5B is a table outlining different machine learning models and the experimental accuracy readings they are able to achieve while using the foundation model as the basis, in accordance with one approach.

FIG. 5C is a graph with plots of the confidence score vs. training sample size for different models for the experiments in FIG. 5A, in accordance with one experimental approach.

FIG. 5D is a graph with plots of the confidence score vs. training sample size for different models for the experiments in FIG. 5B, in accordance with one experimental approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for developing foundation models and using the foundation models as a base for building models that are tailored for a particular purpose. A foundation model develops a broad understanding of a system and the entities therein by evaluating system log information. Accordingly, these tailored models may be developed with minimal development. In some situations, these tailored models may even be developed from the foundation models without performing any additional training. For instance, prompt tuning may be performed on a foundation model by simply providing a few examples along with the desired task, rather than generating and applying significant amounts of training data. Implementations herein are thereby able to significantly simplify the process of developing models (e.g., machine learning models) that are able to successfully perform specific types of tasks, e.g., as will be described in further detail below.

In one general approach, a CIM includes: aggregating system log information and converting the system log information to sentences. The sentences are used to train a foundation model based on the system log information. Moreover, the foundation model is augmented using Siamese augmentation. The foundation model is also tuned for a downstream application. The downstream application can thereby be implemented using the foundation model.

In another general approach, a CPP includes: a set of one or more computer-readable storage media. Moreover, program instructions are collectively stored in the set of one or more storage media. The program instructions are for causing a processor set to perform the foregoing CIM.

In yet another general approach, a CS includes: a processor set and a set of one or more computer-readable storage media. The CS also includes program instructions that are collectively stored in the set of one or more storage media. The program instructions are for causing the processor set to perform the foregoing CIM.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved system analysis code at block 150 for developing foundation models and using the foundation models as a base for efficiently building models that are tailored for a particular purpose. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

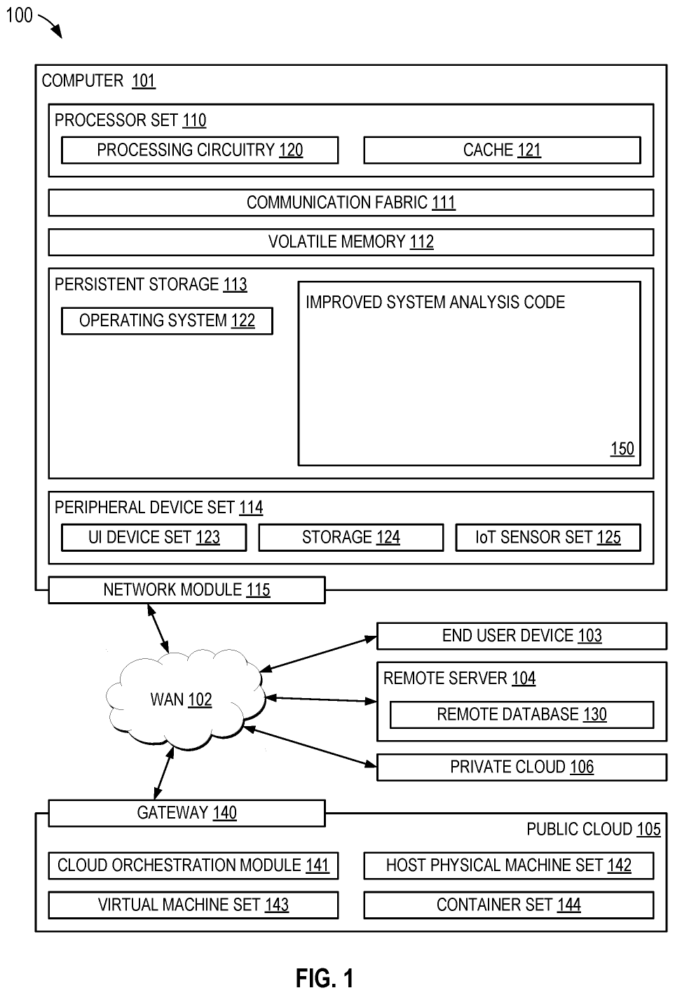

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a CIM may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a CIM, such that the instructions thus executed will instantiate the methods specified in flowcharts and/or narrative descriptions of CIMs included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As noted above, conventional applications of artificial intelligence involve building rule based systems or machine learning models that are task specific. In other words, models are developed and trained for a specific assignment. For example, a conventional anomaly detection system that applies machine learning is formed by creating training data for the particular problem being faced, and using the training data to teach the system. This is a complex and resource intensive process. Furthermore, as the problem changes over time, new training data must be developed and used to modify the abilities of the system. Thus, a substantial amount of training data is developed and used to maintain these conventional machine learning based systems. It follows that conventional products have suffered from significant inefficiencies, particularly in applications that involve dynamic problems.

In sharp contrast, implementations herein use foundation models to mitigate the focus placed on generating training data for each problem or task. As used herein, a “foundation model” is intended to refer to any artificial intelligence based model that is trained on a broad set of information such that it may be applied across a wide range of use cases. Implementations herein build foundation models using system log information to gain a broad understanding of system behavior. This allows a foundation model to be deployed across a broad range of situations in a system without performing any additional training. For instance, the foundation models developed herein may be applied across a broad range of different security applications.

In other words, by training foundation models using system log information as described in approaches herein, the foundation models obtain a basic understanding of the systems that generated the system log information. The foundation models are thereby able to identify and understand various components in systems, e.g., such as system files, networks that are connected to the system, users with access to the system, etc., and other general knowledge.

These foundation models may also be used as a base (e.g., foundation) for building models that are tailored for a particular purpose. Again, because the foundation model has already developed a broad understanding of a system and the entities therein, these tailored models may be developed with minimal effort. In some situations, these tailored models may even be developed from the foundation models without performing any additional training. For instance, prompt tuning may be performed on a foundation model by simply providing a few examples along with the desired task, rather than generating and applying significant amounts of training data. Implementations herein are thereby able to significantly simplify the process of developing models (e.g., machine learning models) that are able to successfully perform specific types of tasks, e.g., as will be described in further detail below.

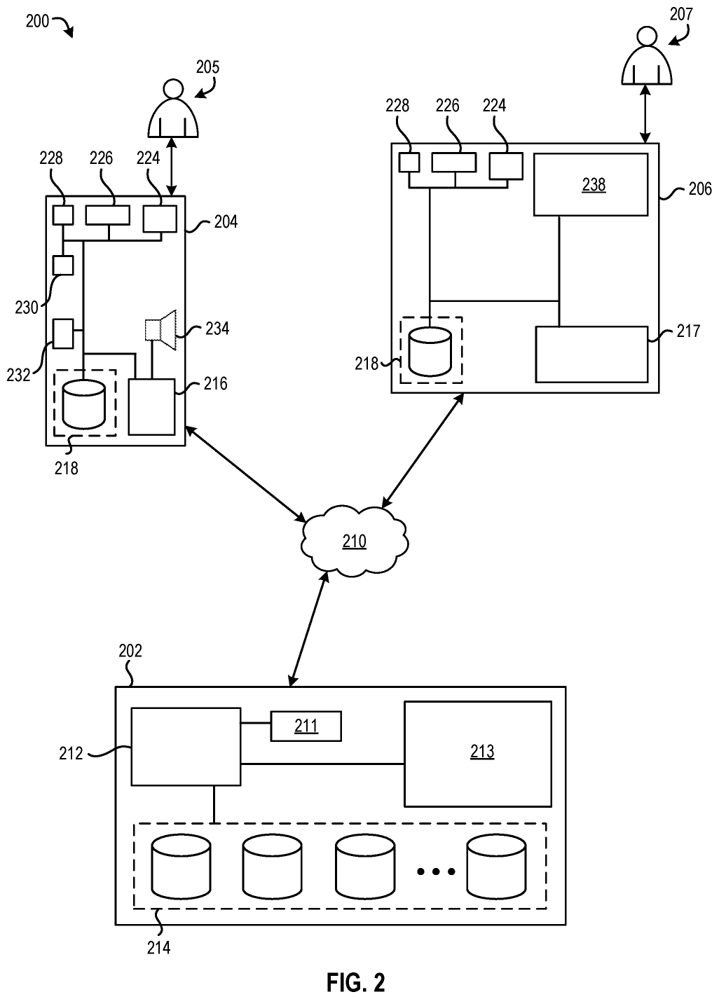

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central server 202 that is connected to a user device 204, and edge node 206 accessible to the user 205 and administrator 207, respectively. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc., or any other type of connection which would be apparent to one skilled in the art after reading the present description.

The terms “user” and “administrator” are in no way intended to be limiting either. For instance, while users and administrators may be described as being individuals in various implementations herein, a user and/or an administrator may be an application, an organization, a preset process, etc. The use of “data” and “information” herein is in no way intended to be limiting either, and may include any desired type of details, e.g., depending on the type of operating system implemented on the user device 204, edge node 206, and/or central server 202. For example, video data, audio data, sensor data, images, etc. may be sent to the central server 202 from user device 204 and/or edge node 206 for processing using one or more artificial intelligence based models, e.g., such as a foundation model and/or machine learning models.

With continued reference to FIG. 2, the central server 202 includes a large (e.g., robust) processor 212 coupled to a cache 211, an artificial intelligence module 213, and a data storage array 214 having a relatively high storage capacity. As noted above, the artificial intelligence module 213 may include any desired number and/or type of artificial intelligence based models. In preferred approaches, the artificial intelligence module 213 and/or processor 212 includes a foundation model that has been trained using system log information that has been received. With respect to the present description, “system log information” is intended to include any type of information that is correlated with the operation of a system. In some approaches, the system log information includes data that is stored in system logs, e.g., such as startup messages, system changes, errors and warnings, etc. It follows that system log information may be received from a source that is in and/or connected to the system 200. For example, system log information may be received from a Security Incident and Event Management (SIEM) system, computational devices, operating systems, etc. In some approaches, the system log information is received from user device 204, edge node 206, or any other source that is connected to the network 210.

Furthermore, the intelligence module 213 and/or processor 212 may include one or more machine learning models that have been developed from the foundation model. In other words, the foundation model provides a general understanding of the system in response to evaluating the system log information. The foundation model may thereby be used as a foundation on which more focused (e.g., tailored) machine learning models may be developed to perform more specific or detailed tasks, e.g., as will be described in further detail below.

With continued reference to FIG. 2, user device 204 includes a processor 216 which is coupled to memory 218. The user device 204 may receive inputs from, and interface with, user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

Some data may be received from user 205 for storage and/or evaluation using artificial intelligence module 213. For instance, system log information may be received as a result of the user 205 using one or more applications, software programs, temporary communication connections, etc. running on the user device 204. For example, the user 205 may upload data for storage at the data storage array 214 and evaluation using processor 212 and/or artificial intelligence module 213 of central server 202. As a result, the data may be evaluated and processed.

Looking now to the edge node 206 of FIG. 2, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an artificial intelligence module 238. As described above with respect to artificial intelligence module 213, the artificial intelligence module 238 may include any desired number and/or type of machine learning models. It follows that artificial intelligence module 238 may implement similar, the same, or different characteristics as artificial intelligence module 213 in central server 202.

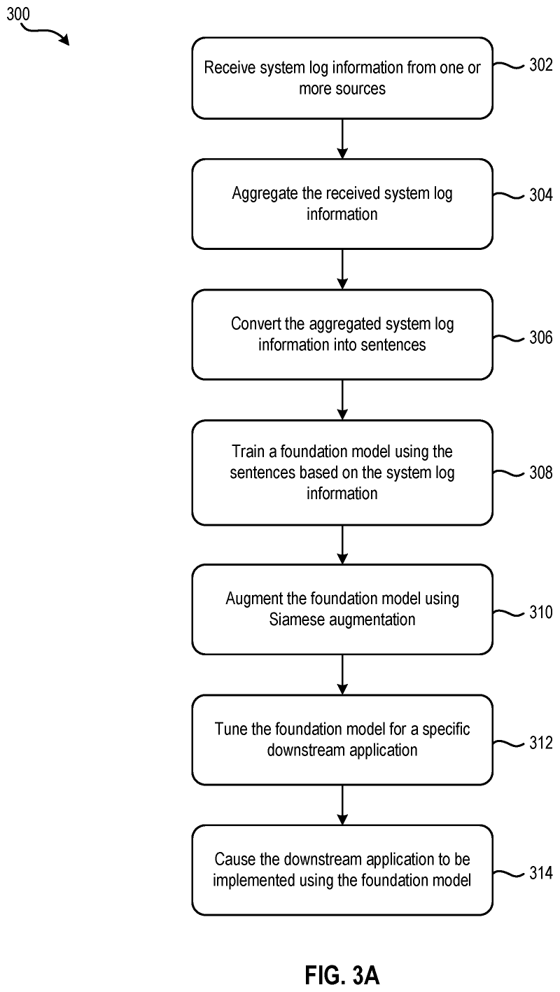

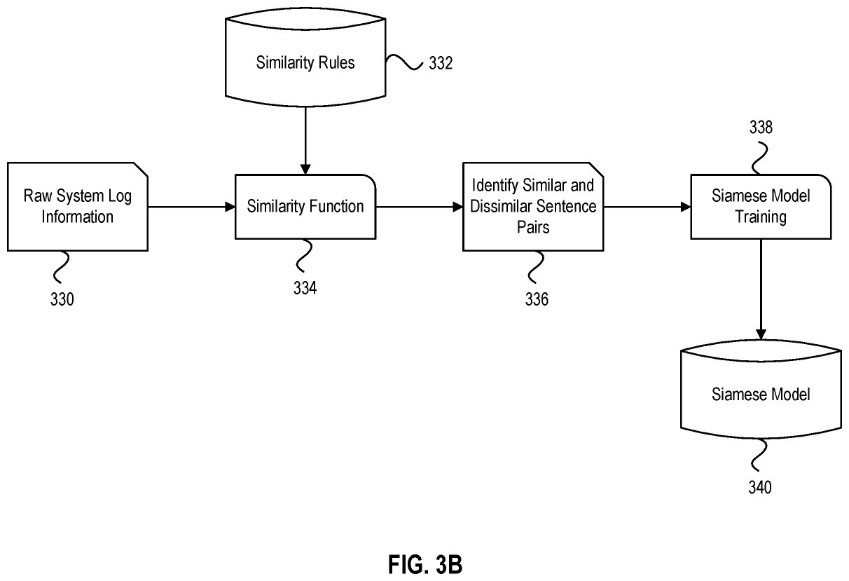

Looking now to FIG. 3A, a flowchart of a CIM 300 for developing foundation models and using the foundation models to successfully address downstream applications is illustrated in accordance with one approach. Method 300 may be performed in accordance with the present invention in any of the environments depicted in FIGS. 1-2, among others, in various approaches.

Of course, more or less operations than those specifically described in FIG. 3A may be included in method 300, as would be understood by one of skill in the art upon reading the present descriptions. Each of the steps of the method 300 may be performed by any suitable component of the operating environment using known techniques and/or techniques that would become readily apparent to one skilled in the art upon reading the present disclosure. In some approaches, one or more processors located at a central server of a distributed system (e.g., see processor 212 of FIG. 2 above) and/or an artificial intelligence based module (e.g., see artificial intelligence based module 213 of FIG. 2 above) may be used to perform one or more of the operations in method 300. In another approach, one or more processors located at an edge server (e.g., see controller 217 of FIG. 2 above) and/or an artificial intelligence based module (e.g., see artificial intelligence based module 238 of FIG. 2 above) may be used to perform one or more of the operations in method 300.

Moreover, in various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

Again, FIG. 3A illustrates the formation, training, and application of foundation models and/or tailored machine learning models based on received system log information. Accordingly, operation 302 includes receiving system log information from one or more sources. As noted above, “system log information” includes any type of information that is correlated with the operation of a system. In some approaches, the system log information includes data that is stored in system logs, e.g., such as startup messages, system changes, errors and warnings, etc. For example, system log information may be received from a Security Incident and Event Management (SIEM) system, computational devices, operating systems, etc.

In response to receiving the system log information, operation 304 includes aggregating the received system log information. Moreover, the aggregated system log information is converted into sentences. See operation 306. With respect to the present description, a “sentence” may include a group of words that express a contextual concept. In other words, the sentence formed in operation 306 involves converting the received system log information into a string of characters and/or values that express a contextual concept in the form of a sentence. For instance, foundation models may be trained to predict the next sentence element (or word) based on the previous elements (or words). Accordingly, the words may be arranged into a structured representation. Operation 306 may thereby include combining related system log information (entries) together into a single structure.

According to an example, which is in no way intended to be limiting, the system log information received in operation 302 may be simplified into the following entries:
8:00 am—Firefox starts
8:01 am—Chrome starts
8:02 am—Firefox connects to youtube.com
8:03 am—Chrome connects to gmail.com
8:02 am—Firefox connects to a video on youtube.com
8:03 am—Chrome downloads an attachment
8:02 am—Firefox closes
8:03 am—Chrome connects to reddit.com
   Operation 306 may thereby include rearranging and combining the entries above to form two distinct sentences. For instance, a first of the sentences may read “8:00 am-Firefox starts→8:02 am-Firefox connects to youtube.com→8:02 am-Firefox connects to a video on youtube.com→8:02 am-Firefox closes,” while a second sentence reads “8:01 am-Chrome starts→8:03 am-Chrome connects to gmail.com→8:03 am-Chrome downloads an attachment→8:03 am-Chrome connects to reddit.com.” However, entries may be arranged, combined, merged, converted, changed, modified, etc., according to the desired approach. According to one approach, the entries in the example above may be arranged such that the corresponding times progress in a descending order. In another approach, the entries may be combined based on the type of entry, ordered based on a median value, according to one or more policies predetermined by a user, etc.

In some approaches, foundation models are designed to interpret natural language data, in which a sentence represents the basic unit of a contextual concept. It follows that in some approaches the foundation models may use natural language sentences as contextual representations of the system log information received in operation 302. The process of converting the aggregated system log information may thereby include actively translating (e.g., transforming) the system log information into natural language sentences in some approaches. According to an example, system security data is typically not represented in linguistic sentences, but rather a list of events that occur in the system. Thus, by converting the system log information into more conceptual sentences, they may be used as inputs for the foundation models, providing insight as to how the system functions. The foundation models may evaluate these received sentences to develop an understanding of how the system operates.

Operation 308 further includes training a foundation model using the sentences based on the system log information. In other words, the foundation model is trained using the sentences that are formed in operation 306 from the system log information that was initially received in operation 302. Depending on the approach, the foundation model may be trained in an unsupervised, semi-supervised, supervised, etc. fashion.

From operation 308, method 300 proceeds to operation 310. There, operation 310 includes augmenting the foundation model using Siamese augmentation. Although pretraining foundation models enables the models to learn the contextual semantics of the respective input tokens, the process does not encode an understanding of sentence-level semantics. In other words, although the sentences formed from the aggregated system log information provide insight on how the system operates generally, the foundation model does not gain an understanding of how the different sentences are related to each other.

Some attempts to measure the similarity between input sentences include comparing shared tokens and their positions in the respective input sentences. Other attempts involve using the foundation model to embed each input sentence and compute a distance (e.g. cosine similarity) within the embedding space. While these approaches are often sufficient for natural language data, they are not sufficient for situations involving security foundation models.

For instance, in security based scenarios (e.g., cybersecurity scenarios), the same or similar system behavior can have multiple different expressions within a log. According to an example, there can be multiple different ways to access a network and download a file, e.g., depending on the process, operating system, type of network, etc. It follows that security based scenarios tend to have a limited number of shared tokens between different sentences. Similarly, two sentences having many tokens in common may represent very different behaviors. For instance, a file read activity and file write activity may have only one different token in the log information, but the meanings of the two sentences are very different. Furthermore, some sentences contain the same sub-events resulting in many shared tokens. However, as sentences are a sequence of tokens, the output of a sentence embedding is simply an amalgamation of the token embeddings in the foundation model, which causes these sentences to be ‘close’ in the embedding space.

It follows that although operation 308 of method 300 includes training a foundation model using the sentences that are formed from the system log information that was initially received, the foundation model undergoes additional processing. For instance, the trained foundation model is further augmented (e.g., trained) to cluster “similar” input sequences together in its embedding space and separate “different” input sequences. As noted above, Siamese augmentation may be used to augment the trained foundation model such that it is able to label an input sequence as being similar to another input sentence in response to determining the input sentences share the same order of log events, or at least a subset thereof.

This augmentation may further be performed without labeled pairs of similar and dissimilar inputs. For instance, while determining the similarity between sentences having labeled pairs of similar and dissimilar inputs can be performed by identifying whether the sentences belong to the same class label, this is not true when dealing with unlabeled data. Thus, some approaches herein use a set of generic similarity rules as a base on which to establish the similarity semantics that the foundation model should learn when comparing system behavior, such as system log information that has been converted into sentences. Thus, as system log information is ingested and converted into semantic sentences, the training pipeline of approaches herein is able to automatically create similar and dissimilar pairs. It should also be noted that these generic similarity rules may be obtained from different sources depending on the approach. For instance, in different approaches one or more similarity rules may be obtained from a subject matter expert (e.g., user) that developed the similarity rules, one or more machine learning models that have been trained to generate similarity rules based on evaluating performance of a system, another system having sufficiently similar settings, etc.

Referring momentarily now to FIG. 3B, exemplary sub-operations of implementing Siamese augmentation are illustrated in accordance with one embodiment. The sub-operations may be performed in order to augment a foundation model using Siamese augmentation. It follows that one or more of the sub-operations in FIG. 3B may be used to perform operation 310 of FIG. 3A. However, it should be noted that the sub-operations of FIG. 3B are illustrated in accordance with one approach which is in no way intended to limit the invention.

As shown, raw system log information 330 along with similarity rules 332 are input into a similarity function 334. The system log information 330 may be received from one or more sources that correspond to a given system. For instance, system log information may be received from a Security Incident and Event Management (SIEM) system, computational devices, operating systems, etc. Moreover, the similarity rules 332 may be received from a subject matter expert (e.g., user) that developed the similarity rules, one or more machine learning models that have been trained to generate similarity rules based on evaluating performance of a system, another system having sufficiently similar settings, etc.

In preferred approaches, the similarity function 334 is a hash function. Accordingly, the raw system log information 330 may be converted into sentences (e.g., semantic sentences) before being input into the similarity function 334. The similarity rules 332 may also be converted into hash values and/or similarity hash functions that may be used to develop or update the similarity hash function 334, e.g., for processing.

In response to evaluating the system log information 330 in view of the similarity rules 332, the similarity hash function 334 outputs a unique identification that is correlated with the system log information 330 that was inspected. In other words, the similarity hash function 334 outputs a unique identification that corresponds to the content of the sentences that were evaluated in view of the similarity rules. The similarity hash function 334 thereby generates a plurality of similarity outputs by applying the similarity hash function to respective ones of the sentences. Moreover, the similarity outputs generated by similarity hash function 334 may be combined into groups. For instance, in some approaches the similarity outputs generated by similarity hash function 334 may be used to create groups of the sentences, e.g., based on the type, structure, language, location, etc., of the information that is in the respective sentences.

In some approaches, each of the similarity outputs that are generated include a unique identifier. It follows that creating groups of sentences based at least in part on generated similarity outputs includes identifying sentences that have a same unique identifier. Moreover, the identified ones of the sentences may be assigned to a same group.

From the similarity hash function 334, the flowchart evaluates the sentences and identifies pairs of the sentences that are similar to each other, as well as pairs of the sentences that are dissimilar (e.g., different) from each other. See sub-operation 336. In other words, sub-operation 336 preferably includes generating similar pairs of the sentences by sampling the sentences from a same one of the groups, as well as generating dissimilar pairs of the sentences by sampling the sentences from different ones of the groups.

Sentences that are “similar” to each other may be identified by the similarity hash function 334 in response to comparing the sentences to the similarity rules 332. For instance, two sentences determined as having unique identification values with a difference that is in a first predetermined range may be identified as being “similar” to each other. Sentences that are “different” from each other may also be identified by the similarity hash function 334 in response to comparing the sentences to the similarity rules 332. For instance, two sentences determined as having unique identification values with a difference that is outside the first predetermined range, or in a second predetermined range, may be identified as being “different” from each other.

In some approaches, the process of determining pairs of sentences that are similar to each other involves inspecting the sentences that are in a same one of the formed groups. Moreover, the sentences in the group being evaluated may be combined into random pairs. As previously mentioned, in some approaches it is preferred that each of the sentences in the given one of the groups is only included in one of the combined random pairs. However, this is in no way intended to be limiting.

In some approaches, the process of determining pairs of sentences that are similar to each other involves assuming there are “S” similarity groups, with each of the “S” similarity groups having a unique hash identification. Moreover, for each “S” similarity group, “K” different random sentence pairs may be generated, such that each sentence is only part of one sentence pair (i.e., each sentence is part of no more than one sentence pair). As a result, there will be S×K different similar sentence pairs.

In some approaches, the process of determining pairs of sentences that are dissimilar to each other involves comparing the sentences that are in different ones of the formed groups. For instance, a predetermined number of the sentences may be sampled from each of the formed groups. Moreover, the sentences in a group being evaluated may be combined into random pairs with sentences from different groups. For instance, each of the sentences in one of the groups may be combined with a respective sentence in a different one of the groups. It may also be preferred that each of the sentences in the given one of the groups is only included in one of the combined random pairs. However, this is in no way intended to be limiting.

In some approaches, the process of determining pairs of sentences that are different (e.g., dissimilar) to each other involves assuming there are “S₂” similarity groups. Moreover, “n” sentences may be sampled from each of the “S₂” similarity groups to determine the different sentence pairs. These different sentence pairs may be generated by pairing each sampled sentence with a sentence from a different similarity group. As a result, there will be (S×n)/2 pairs of different sentences. This process may be repeated any desired number of times to develop a desired number of different sentence pairs. For instance, it is preferred in some approaches that the number of dissimilar sentence pairs is greater than or equal to the number of similar sentence pairs. In other words, it is desirable in some approaches that there are more pairs of different sentences than there are pairs of similar sentences. The balance between similar and dissimilar pairs can be adjusted based on user or task details and additional group granularity can be added. For instance, a user that wishes to ensure a specific distribution may use specific types of dissimilar pairs. According to an example, which is in no way intended to be limiting, the sentence pairs may include about 50% process-process, about 25% process-file, and about 25% process-network, e.g., as would be appreciated by one skilled in the art after reading the present description.

From sub-operation 336, the similar and dissimilar sentence pairs may be used to perform Siamese augmentation. For instance, sub-operation 338 includes performing Siamese model training using the similar and different sentence pairs developed in sub-operation 336. Moreover, a Siamese model is generated in response to performing the Siamese augmentation. See sub-operation 340. The generated Siamese model may be stored in memory, sent to a user, loaded into a controller, etc. It should be noted that a “Siamese model” as used herein may refer to a foundation model that has been modified as a result of performing Siamese model training on system log information, e.g., as described herein.

Returning now to FIG. 3A, it follows that operation 310 includes augmenting the foundation model using Siamese augmentation. In other words, the foundation model is updated based on identified pairs of similar sentences as well as pairs of dissimilar sentences. This allows the foundation model to better understand systems' behavioral similarities.

Proceeding from operation 310 to operation 312, the method 300 further includes tuning the foundation model for a specific downstream application. According to an example, which is in no way intended to be limiting, a trained foundation model may be tuned (e.g., modified) such that it is configured to perform one or more security based (e.g., cybersecurity related) routines or operations.

Unlike traditional machine learning practices which build many different task-specific models, implementations herein utilize foundation models that have been trained to possess a general understanding of how a system operates. These foundation models may thereby be easily fine-tuned to perform different tasks that are more focused on a specific aspect of the system and how it operates. For example, because approaches herein are able to train a foundation model to understand the behavioral aspects of systems and networks, the foundation model can be used as a base to develop various event detection applications, e.g., such as alert detection, process behavior classification, Tactics, Techniques, and Procedures (TTP) tagging, user detection, etc.

An illustrative list of security based (e.g., cybersecurity related) downstream applications that a foundation model may be used to form includes, but is in no way limited to, alert detection (e.g., flag sentences that express suspicious system activity) and explanation (e.g., explain what events in the sentence are responsible for an alert detection), behavior identification, TTP tagging (e.g., identify the attack technique used in suspicious sentence), behavior classification (e.g., given a sentence or group of sentences belonging to the same entity, identify a system entity the sentences appears to be acting as), anomalous behavior (IoB) detection (e.g., using the behavior classification model to identify log events in which the predicted system entity deviates from the logged system entity), similar behavior search (e.g., given a sentence, find other sentences in the foundation models embedding space that exhibit semantically similar behavior), behavior rules that can express a security or alert based rule in the embedding space of the foundation model rather than use traditional rules and/or regular expressions, etc.

A security based foundation model that is used to develop a model (e.g., machine learning model) that is fine-tuned to perform one or more of the foregoing applications will desirably improve the efficiency of threat detection and hunting. Further, these downstream models can be produced using a small amount of labelled data for the target task since the foundation model provides a vast amount of underlying domain knowledge. It follows that foundation models may be used to easily develop tailored machine learning models that are able to perform specific tasks by utilizing the broad understanding of system performance that the foundation models have developed.

Referring still to FIG. 3A, the specific downstream application(s) developed using the foundation model are preferably implemented. In other words, the tailored models developed from the base foundation model are preferably used to evaluate incoming information. Accordingly, operation 314 includes causing the downstream application to be implemented using the foundation model.

It follows that approaches herein are able to train foundation models using system log information. One issue with system log information in comparison to other data, is that related system activity in the log information may be spread across different sections in the log. Thus, in addition to training a foundation model to learn the relationship between tokens, a security foundation model also learns to understand the system behaviors. Accordingly, a foundation model that has been pre-trained with a wide range of logs can understand nuanced meanings in different contexts and can gain deeper knowledge about the system behaviors which are agnostic to specific applications and systems.

Thus, by discovering and connecting multiple related system log information (e.g., behavior related to a specific process) to create a contextual string representation in the form of a “sentence,” approaches herein improve the evaluation of data inputs. One way to capture the behavioral aspects of log information is to connect the corresponding events through related system objects, e.g., such as files and networks. For example, the log entries that access the same file or network within a predetermined time window across the log information may be converted into a sentence. This desirably provides insights on the process behaviors, e.g., such as file and network accesses.

Further, as logs from different systems have different information granularity, format, schema, etc., sentence abstraction may be used to form a common input representation irrespective of log type. Training a foundation model on a diverse set of log information across multiple systems will improve its performance, as it will learn a diverse set of contextual semantics and can begin to correlate different representations of the same behaviors. This allows foundation models herein to be agnostic to specific applications and systems, and thus can be used to build models for different systems and use cases.

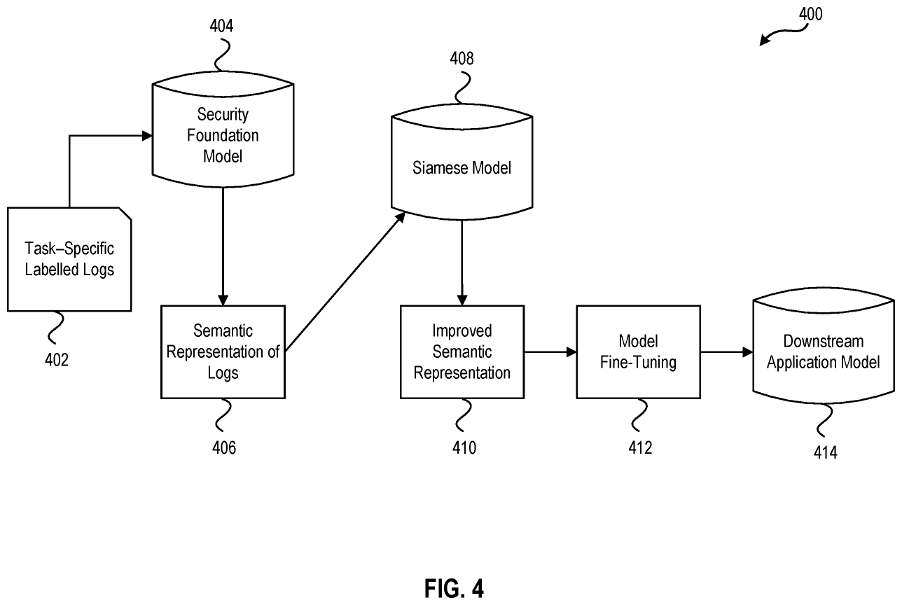

According to an in-use example, which is in no way intended to be limiting, FIG. 4 illustrates a method 400 of developing tailored machine learning models that are configured to perform specific downstream applications. As noted above, these tailored machine learning models are generated using a foundation model that has been developed to possess a general understanding of how a system operates. It follows that method 400 may be performed in accordance with the present invention in any of the environments depicted in FIGS. 1-3B, among others, in various approaches.

Moreover, in various approaches, the method 400 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown, task specific labeled logs 402 are obtained and provided to a security based foundation model 404. The task specific labeled logs 402 may be received from a user that generated the labeled logs in some approaches. In other approaches, the task specific labeled logs 402 may be formed as a result of evaluating a system and the log information produced by the system during operation thereof. Moreover, the foundation model may be a base version configured to be modified by the received system log information.

The security based foundation model 404 produces a semantic representation of the system log information. See operation 406. In other words, the system log information is converted into sentences which may be used to further train the foundation model. Specifically, the sentences are used to develop a Siamese model 408 which is able to produce an improved semantic representation of the system log information. See operation 410. This more detailed understanding of the system log information may further be used to perform fine-tuning of the already trained foundation model at operation 412, thereby producing a downstream application model 414 that may be tailored to perform a specific function.

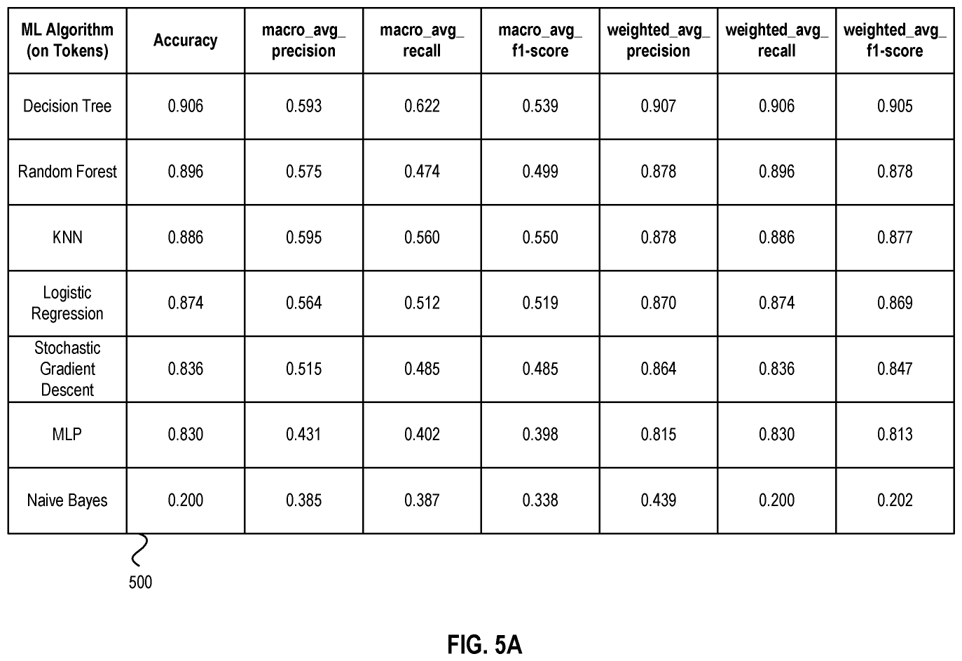

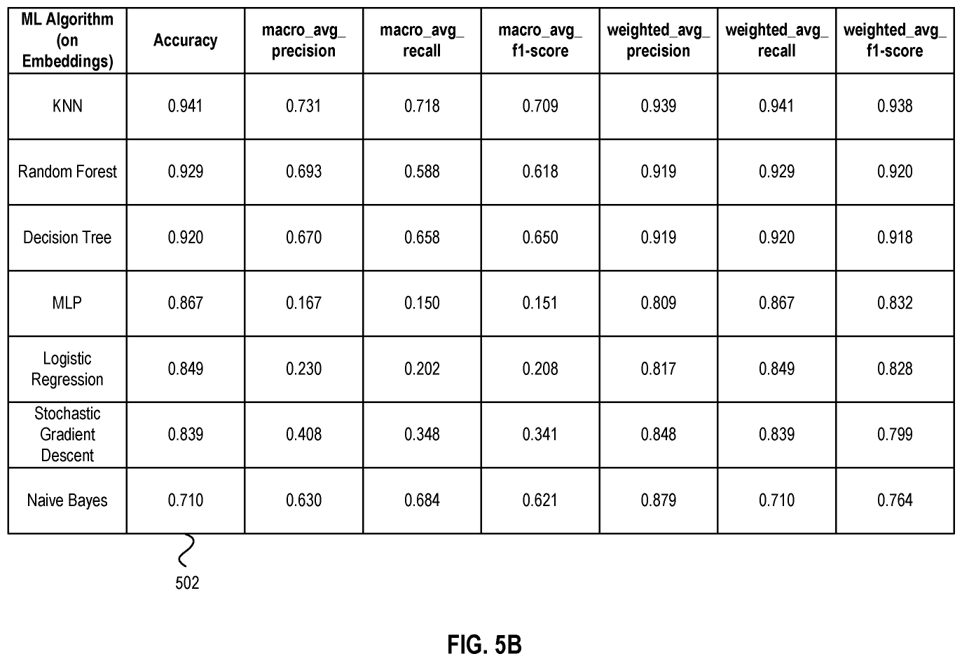

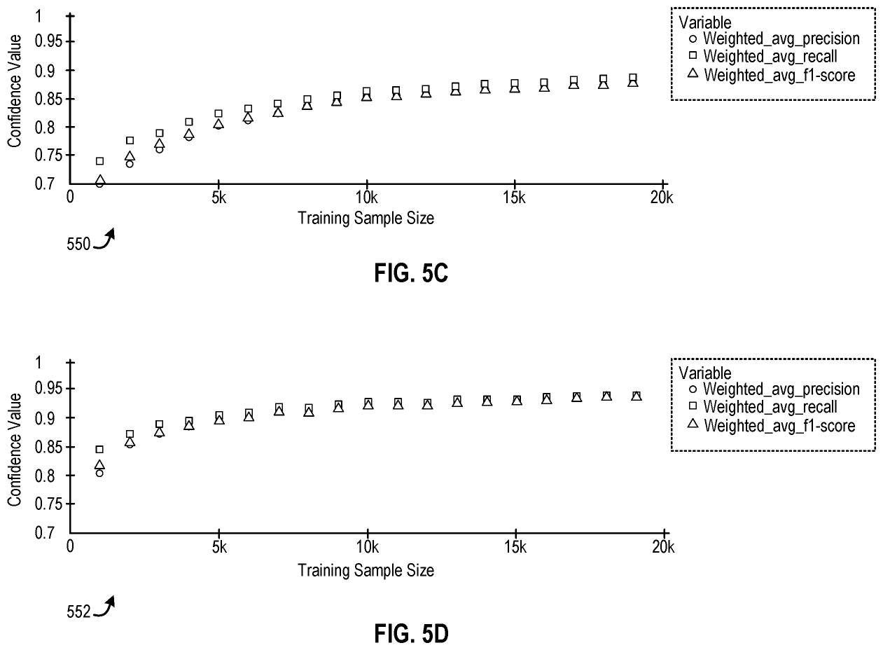

Looking now to FIGS. 5A-5D, the improvements achieved by the approaches herein are illustrated in the context of another in-use example, which again is in no way intended to be limiting. Specifically, FIGS. 5A, 5B include tables 500, 502 which include the results from preliminary experiments that have been conducted to illustrate the improvements achieved by using system log information to develop foundation models as well as models tailored for specific tasks. For reference, table 500 in FIG. 5A shows results achieved using machine learning models that have been trained using log tokens exclusively. These results are in sharp contrast to the results in table 502 of FIG. 5B which includes the results achieved by tailored machine learning models developed from a base foundation model that has a broad understanding of system performance.

These improvements are further shown looking to graphs 550, 552 of FIGS. 5C-5D, respectively. For instance, graph 550 of FIG. 5C shows that models developed using a token-based approach achieve a much lower confidence values than models developed using embeddings associated with a base foundation model that has been trained on system log information. For example, graph 552 of FIG. 5D illustrates that a much higher confidence value may be achieved for a given training sample size in comparison to the confidence value achieved in graph 550 of FIG. 5C for the same training sample size.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A computer-implemented method (CIM), comprising:
aggregating system log information;
converting the system log information to sentences;
training a foundation model using the sentences based on the system log information;
augmenting the foundation model using Siamese augmentation;
tuning the foundation model for a downstream application; and
causing the downstream application to be implemented using the foundation model.

2. The CIM of claim 1, wherein the augmenting of the foundation model using Siamese augmentation includes:
converting a set of similarity rules corresponding to the system log information into a similarity hash function;
generating a plurality of similarity outputs by applying the similarity hash function to respective ones of the sentences;
creating groups of the sentences based at least in part on the similarity outputs;
generating similar pairs of the sentences by sampling the sentences from a same one of the groups;
generating dissimilar pairs of the sentences by sampling the sentences from different ones of the groups; and
performing the Siamese augmentation using the similar pairs and the dissimilar pairs.

3. The CIM of claim 2, wherein each of the similarity outputs is a unique identifier, wherein creating groups of the sentences based at least in part on the similarity outputs includes:
identifying ones of the sentences having a same unique identifier;
and assigning the identified ones of the sentences to a same one of the groups.

4. The CIM of claim 1, wherein the generating similar pairs of the sentences includes, for each of the groups of the sentences:
combining the sentences in a given one of the groups into random pairs.

5. The CIM of claim 4, wherein each of the sentences in the given one of the groups is only included in one of the combined random pairs.

6. The CIM of claim 4, wherein the generating dissimilar pairs of the sentences includes:
sampling a predetermined number of the sentences from each of the groups; and
combining each of the sentences in a given one of the groups with a respective sentence in a different one of the groups.

7. The CIM of claim 6, wherein a number of the dissimilar pairs that are generated is greater than a number of the similar pairs that are generated.

8. The CIM of claim 1, wherein the downstream application is a cybersecurity application.

9. The CIM of claim 1, wherein the system log information is received from a source selected from the group consisting of: Security Incident and Event Management (SIEM) systems, computational devices, and operating systems.

10. A computer program product (CPP), comprising:
a set of one or more computer-readable storage media; and
program instructions, collectively stored in the set of one or more storage media, for causing a processor set to perform the following computer operations:
aggregate system log information;
convert the system log information to sentences;
train a foundation model using the sentences based on the system log information;
augment the foundation model using Siamese augmentation;
tune the foundation model for a downstream application; and
cause the downstream application to be implemented using the foundation model.

11. The CPP of claim 10, wherein the augmenting of the foundation model using Siamese augmentation includes:
converting a set of similarity rules corresponding to the system log information into a similarity hash function;
generating a plurality of similarity outputs by applying the similarity hash function to respective ones of the sentences;
creating groups of the sentences based at least in part on the similarity outputs;
generating similar pairs of the sentences by sampling the sentences from a same one of the groups;
generating dissimilar pairs of the sentences by sampling the sentences from different ones of the groups; and
performing the Siamese augmentation using the similar pairs and the dissimilar pairs.

12. The CPP of claim 11, wherein each of the similarity outputs is a unique identifier, wherein creating groups of the sentences based at least in part on the similarity outputs includes:
identifying ones of the sentences having a same unique identifier;
and assigning the identified ones of the sentences to a same one of the groups.

13. The CPP of claim 10, wherein the generating similar pairs of the sentences includes, for each of the groups of the sentences:
combining the sentences in a given one of the groups into random pairs.

14. The CPP of claim 13, wherein each of the sentences in the given one of the groups is only included in one of the combined random pairs.

15. The CPP of claim 13, wherein the generating dissimilar pairs of the sentences includes:
sampling a predetermined number of the sentences from each of the groups; and
combining each of the sentences in a given one of the groups with a respective sentence in a different one of the groups.

16. The CPP of claim 15, wherein a number of the dissimilar pairs that are generated is greater than a number of the similar pairs that are generated.

17. The CPP of claim 10, wherein the downstream application is a cybersecurity application.

18. The CPP of claim 10, wherein the system log information is received from a source selected from the group consisting of: Security Incident and Event Management (SIEM) systems, computational devices, and operating systems.

19. A computer system (CS), comprising:
a processor set;
a set of one or more computer-readable storage media;
program instructions, collectively stored in the set of one or more storage media, for causing the processor set to perform the following computer operations:
aggregate system log information;
convert the system log information to sentences;
train a foundation model using the sentences based on the system log information;
augment the foundation model using Siamese augmentation;
tune the foundation model for a downstream application; and
cause the downstream application to be implemented using the foundation model.

20. The CS of claim 19, wherein the augmenting of the foundation model using Siamese augmentation includes:
converting a set of similarity rules corresponding to the system log information into a similarity hash function;
generating a plurality of similarity outputs by applying the similarity hash function to respective ones of the sentences;
creating groups of the sentences based at least in part on the similarity outputs;
generating similar pairs of the sentences by sampling the sentences from a same one of the groups;
generating dissimilar pairs of the sentences by sampling the sentences from different ones of the groups; and
performing the Siamese augmentation using the similar pairs and the dissimilar pairs.
